(19) United States
(12) Patent Application Publication
(10) Pub. No.: US 2009/0015945 A1
(43) Pub. Date: Jan. 15, 2009

(54) LENS UNIT PROVIDED WITH AN ENGAGING STRUCTURE AND A LENS MODULE INCORPORATING THE SAME

(76) Inventor: YI-JEN CHEN, Taichung (TW)

Correspondence Address: TROP PRUNER & HU, PC, 1616 S. VOSS ROAD, SUITE 750, HOUSTON, TX, 77057-2631, US

(21) Appl. No.: 12/143,988

(22) Filed: Jun. 23, 2008

(30) Foreign Application Priority Data
Jul. 13, 2007 (TW) 096125632

(51) Int. Cl. G02B 7/02

(52) U.S. Cl. 359/819

(57) ABSTRACT

A lens unit includes first and second lenses. The first lens includes a first optically effective portion having a first center aligned with an optical axis, and a first positioning portion surrounding the first optically effective portion. The first lens is provided with a groove unit extending circumferentially about the first center at the first positioning portion. The second lens has a second inner side confronting the first lens, and includes a second optically effective portion having a second center aligned with the optical axis, and a second positioning portion surrounding the second optically effective portion. The second lens is provided with a protrusion unit that extends circumferentially about the second center at the second positioning portion and that is received in the groove unit.

### CROSS-REFERENCE TO RELATED APPLICATION

This application claims priority of Taiwanese Application No. 096125632, filed on Jul. 13, 2007.

### BACKGROUND OF THE INVENTION

1. Field of the Invention

The invention relates to a lens unit, more particularly to a lens unit provided with an engaging structure and to a lens module incorporating the same.

2. Description of the Related Art

As shown in FIG. 1, a conventional lens module 1 includes a lens barrel 11 and a lens unit 12. The lens barrel 11 includes a barrel wall 111 defining an optical axis 100 and a receiving space 112. The lens unit 12 includes first and second lenses 121, 122 that are disposed in the receiving space 112. The first lens 121 has a first peripheral surface 123, which cooperates with the barrel wall 111 to define a first crevice 101 therebetween. The second lens 122 has a second peripheral surface 124, which cooperates with the barrel wall 111 to define a second crevice 102 therebetween.

The conventional lens module 1 has the following shortcomings:

1. During manufacture, dimensions of the barrel wall 111 and the first and second peripheral surfaces 123, 124 of the first and second lenses 121, 122 need to be precisely within corresponding tolerances. When the dimensions of one of the barrel wall 111 and the first and second peripheral surfaces 123, 124 fall outside of the corresponding tolerance, at least one of the first and second crevices 101, 102 will be non-ideal, resulting in misalignment of centers of the first and second lenses 121, 122 with the optical axis 100. Consequently, imaging resolution is degraded, and optical performance of the conventional lens module 1 is adversely affected.

2. In order to ensure optical performance of the conventional lens module 1, it is preferable for the first and second crevices 101, 102 to be identical and extremely small. Therefore, it is relatively difficult to assemble the lens unit 12 to the lens barrel 11.

Shown in FIG. 2 is a sectional diagram of another conventional lens module 2 disclosed in Japanese Patent No. 3739295. The conventional lens module 2 includes a lens barrel 21 and a lens unit 22. The lens barrel 21 includes a barrel wall 211 that defines a receiving space 212. The lens unit 22 is disposed in the receiving space 212, and includes a first lens 221 and two second lenses 222. Each of the first and second lenses 221, 222 includes an optically effective portion 223, a positioning portion 224 surrounding the optically effective portion 223, and an extending portion 225 extending from the positioning portion 224. The extending portion 225 of the first lens 221 has an outer surrounding surface 226 extending parallel to an optical axis 200, and an inner tapered surface 227. The extending portion 225 of each of the second lenses 222 has an outer surrounding surface 226, an inner tapered surface 227, and an outer tapered surface 228.

The barrel wall 211 cooperates with the outer surrounding surfaces 226 of the first and second lenses 221, 222 to respectively define a first crevice 201 and two second crevices 202 therebetween. The inner tapered surface 227 of the first lens 221 abuts against the outer tapered surface 228 of one of the second lenses 222, and the inner tapered surface 227 of the one of the second lenses 222 abuts against the outer tapered surface 228 of the other one of the second lenses 222. For the conventional lens module 2, it is only necessary for the first lens 221 and the barrel wall 211 to be precisely within corresponding tolerances, i.e., it is only necessary to control tolerance of the first crevice 201. It is also easier for centers of the optically effective portions 223 of the first and second lenses 221, 222 to be aligned with the optical axis 200 as compared to the conventional lens module 1 described above. However, the conventional lens module 2 still has the following shortcomings:

1. The extending portions 225 are bulky, making overall size of the conventional lens module 2 large as well. Consequently, the conventional lens module 2 cannot be applied to small devices, such as cell phones and slim cameras.

2. The bulky size of the extending portions 225 results in a large amount of material required for producing the lenses 221, 222, thereby increasing the manufacturing cost of the conventional lens module 2.

3. Since corresponding ones of the inner and outer tapered surfaces 227, 228 are disposed in surface contact with each other, if the corresponding ones of the inner and outer tapered surfaces 227, 228 abut each other too tightly, stress or deformation can result in the optically effective portions 223, thereby adversely affecting the imaging resolution. Therefore, there is still room for improvement in terms of optical performance.

4. If distance between corresponding pairs of the inner and outer tapered surfaces 227, 228 is too large when the adjacent first and second lenses 221, 222 already abut against each other, alignment of the centers of the optically effective portions 223 with the optical axis 200 cannot be ensured, thereby degrading the optical performance of the conventional lens module 2.

### SUMMARY OF THE INVENTION

Therefore, the object of the present invention is to provide a lens unit that has enhanced optical performance, that is easy to assemble, that is smaller in size, and that can be fabricated at a lower cost as compared to the prior art. Another object of the present invention is to provide a lens module incorporating the lens unit.

According to one aspect of the present invention, there is provided a lens unit that includes first and second lenses. The first lens has a first inner side and a first outer side opposite to the first inner side. The first lens includes a first optically effective portion that has a first center aligned with an optical axis, and a first positioning portion that surrounds the first optically effective portion. The first lens is provided with a groove unit that extends circumferentially about the first center at the first positioning portion from the first inner side toward the first outer side. The second lens has a second inner side confronting the first inner side of the first lens, and a second outer side opposite to the second inner side. The second lens includes a second optically effective portion that has a second center aligned with the optical axis, and a second positioning portion that surrounds the second optically effective portion. The second lens is provided with a protrusion unit that extends circumferentially about the second center at the second positioning portion from the second inner side toward the first inner side, and that is received in the groove unit of the first lens.

According to another aspect of the present invention, there is provided a lens module that includes a lens barrel and a lens unit.

The lens barrel includes a barrel wall that defines an optical axis and a receiving space.

The lens unit includes first and second lenses. The first lens has a first inner side, a first outer side opposite to the first inner side, and a first peripheral surface interconnecting the first inner side and the first outer side. The first lens includes a first optically effective portion that has a first center aligned with the optical axis, and a first positioning portion that surrounds the first optically effective portion. The first lens is provided with a groove unit that extends circumferentially about the first center at the first positioning portion from the first inner side toward the first outer side. The first lens is disposed in the receiving space such that a first crevice is formed between the first peripheral surface and the barrel wall.

The second lens has a second inner side confronting the first inner side of the first lens, a second outer side opposite to the second inner side, and a second peripheral surface interconnecting the second inner side and the second outer side. The second lens includes a second optically effective portion that has a second center aligned with the optical axis, and a second positioning portion that surrounds the second optically effective portion. The second lens is provided with a protrusion unit that extends circumferentially about the second center at the second positioning portion from the second inner side toward the first inner side, and that is received in the groove unit of the first lens. The second lens is disposed in the receiving space such that a second crevice is formed between the second peripheral surface and the barrel wall.

### BRIEF DESCRIPTION OF THE DRAWINGS

Other features and advantages of the present invention will become apparent in the following detailed description of the preferred embodiments with reference to the accompanying drawings, of which:

FIG. 1 is a sectional view of a conventional lens module;

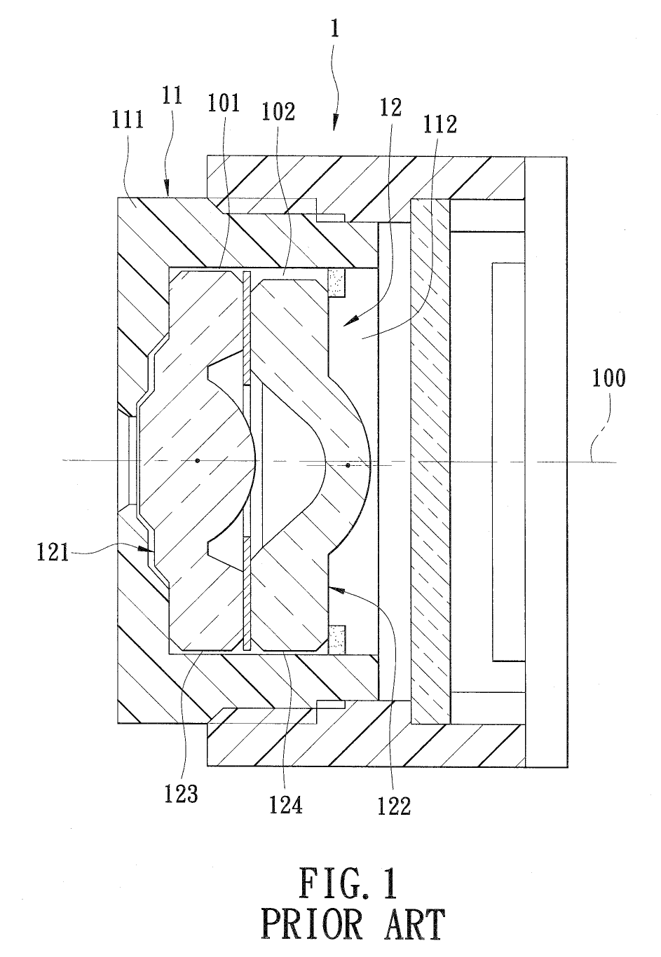

FIG. 2 is a sectional view of another conventional lens module;

FIG. 3 is a sectional view of the first preferred embodiment of a lens module according to the present invention;

FIG. 4 is a back view of a first lens of a lens unit according to the first preferred embodiment;

FIG. 5 is a front view of a second lens of the lens unit according to the first preferred embodiment;

FIG. 6 is a sectional view of the second preferred embodiment of a lens module according to the present invention;

FIG. 7 is a back view of the first lens of the lens unit according to the second preferred embodiment; and

FIG. 8 is a front view of the second lens of the lens unit according to the second preferred embodiment.

### DETAILED DESCRIPTION OF THE PREFERRED EMBODIMENTS

Before the present invention is described in greater detail, it should be noted that like elements are denoted by the same reference numerals throughout the disclosure.

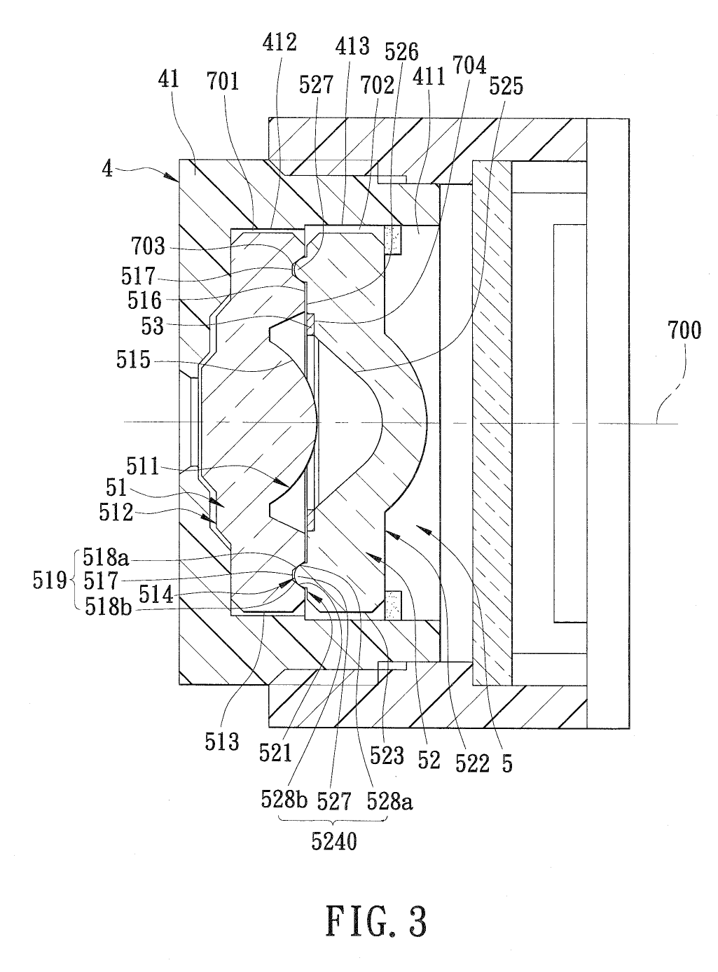

With reference to FIG. 3, which illustrates a sectional view of the first preferred embodiment of a lens module according to the present invention, the lens module includes a lens barrel 4 and a lens unit 5.

The lens barrel 4 includes a barrel wall 41 that defines an optical axis 700 and a receiving space 411. In this embodiment, the barrel wall 41 includes first and second wall segments 412, 413 that cooperate with each other to form a step junction therebetween, and that respectively define first and second receiving sub-spaces of the receiving space 411.

The lens unit 5 is disposed in the receiving space 411, and includes a first lens 51 and a second lens 52.

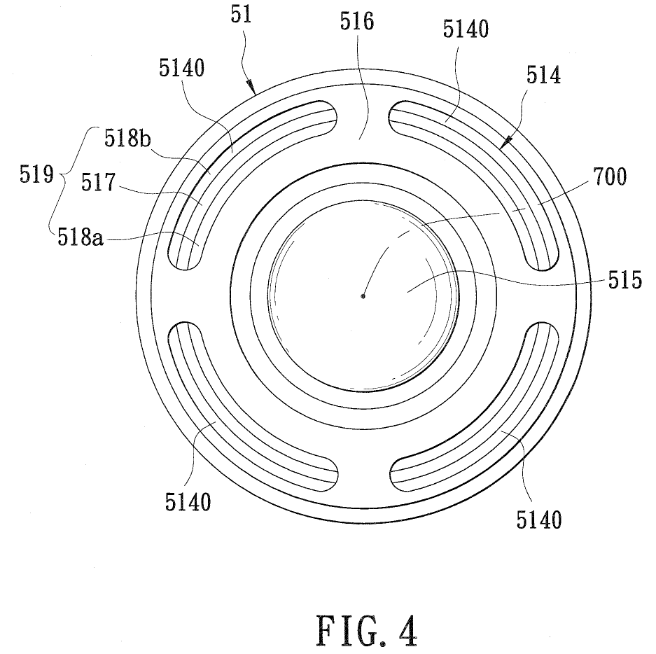

With further reference to FIG. 4, which is a back view of the first lens 51, the first lens 51 has a first inner side 511, a first outer side 512 opposite to the first inner side 511, and a first peripheral surface 513 interconnecting the first inner side 511 and the first outer side 512.

The first lens 51 includes a first optically effective portion 515 that has a first center aligned with the optical axis 700, and a first positioning portion 516 that surrounds the first optically effective portion 515.

The first lens 51 is disposed in the receiving space 411 such that a first crevice 701 is formed between the first peripheral surface 513 and the barrel wall 41. In this embodiment, the first lens 51 is disposed in the first receiving sub-space of the receiving space 411 such that the first crevice 701 is formed between the first peripheral surface 513 and the first wall segment 412 of the barrel wall 41.

The first lens 51 is provided with a groove unit 514 that extends circumferentially about the first center at the first positioning portion 516 from the first inner side 511 toward the first outer side 512.

The groove unit 514 includes a groove wall 519 that defines a groove 5140 and that includes a groove bottom part 517, and inner and outer groove edge parts 518a, 518b that have the groove bottom part 517 connected therebetween. The inner and outer groove edge parts 518a, 518b are respectively disposed proximate to and distal from the first center.

In this embodiment, the groove unit 514 of the first lens 51 includes a plurality of the groove walls 519 respectively defining a plurality of the grooves 5140 that are angularly spaced apart from each other. Each of the grooves 5140 extends circumferentially about the first center at the first positioning portion 516 from the first inner side 511 toward the first outer side 512. For illustrative purposes, four grooves 5140 are illustrated in FIG. 4.

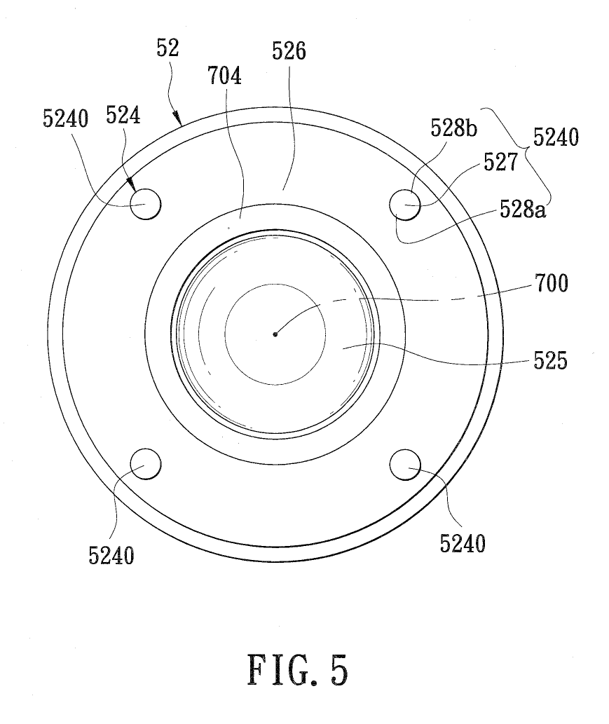

With further reference to FIG. 5, which is a front view of the second lens 52, the second lens 52 has a second inner side 521 confronting the first inner side 511 of the first lens 51, a second outer side 522 opposite to the second inner side 521, and a second peripheral surface 523 interconnecting the second inner side 521 and the second outer side 522.

The second lens 52 includes a second optically effective portion 525 that has a second center aligned with the optical axis 700, and a second positioning portion 526 that surrounds the second optically effective portion 525.

The second lens 52 is provided with a protrusion unit 524 that extends circumferentially about the second center at the second positioning portion 526 from the second inner side 521 toward the first inner side 511, and that is received in the groove unit 514 of the first lens 41.

The second lens 52 is disposed in the receiving space 411 such that a second crevice 702 different in size from the first crevice 701 is formed between the second peripheral surface 523 and the barrel wall 41. In this embodiment, the size of the first crevice 701 is smaller than that of the second crevice 702. In addition, the second lens 52 is disposed in the second receiving sub-space of the receiving space 411 such that the second crevice 702 is formed between the second peripheral surface 523 and the second wall segment 413 of the barrel wall 41.

The protrusion unit 524 includes a protrusion 5240 that has a protrusion tip part 527, and inner and outer contact parts 528a, 528b that have the protrusion tip part 527 connected therebetween. In this embodiment, the protrusion unit 524 includes a plurality of the protrusions 5240 that are angularly spaced apart from each other. Each of the protrusions 5240 extends circumferentially about the second center at the second positioning portion 526 from the second inner side 521 toward the first inner side 511, and is received in a corresponding one of the grooves 5140. For illustrative purposes, four protrusions 5240 are illustrated in FIG. 5.

The protrusion tip part 527 of each of the protrusions 5240 is spaced apart from the groove bottom part 517 of a corresponding one of the groove walls 519, i.e., a space 703 is formed between the protrusion tip part 527 and the groove bottom part 517, when the protrusion 5240 is received in the groove 5140 defined by the corresponding one of the groove walls 519. The inner and outer contact parts 528a, 528b of each of the protrusions 5240 are disposed in contact with the inner and outer groove edge parts 518a, 518b of the corresponding one of the groove walls 519, respectively.

In this embodiment, the groove bottom part 517 of each of the groove walls 519 is a flat surface that extends perpendicularly to the optical axis 700. The inner and outer groove edge parts 518a, 518b of each of the groove walls 519 extend away from each other at an angle with respect to the optical axis 700 and to the groove bottom part 517. The inner and outer contact parts 528a, 528b and the protrusion tip part 527 of each of the protrusions 5240 collectively form a hemispherical shape. The inner and outer contact parts 528a, 528b are disposed in point contact with the inner and outer groove edge parts 518a, 518b, respectively.

Moreover, the lens unit 5 further includes an annular light-shading screen 53. One of the first and second positioning portions 516, 526 is formed with an annular screen-receiving groove 704 for receiving the light-shading screen 53 therein and for retaining the light-shading screen 53 between the first and second lenses 51, 52. In this embodiment, the annular screen-receiving groove 704 is formed in the second inner side 521 of the second lens 52 and is disposed between the protrusion unit 524 and the second center.

The lens module according to the present invention has the following advantages:

1. As long as each of the protrusions 5240 is received in the groove 5140 defined by the corresponding one of the groove walls 519, alignment of the first and second centers of the first and second optically effective portions 515, 525 with the optical axis 700 is maintained, without having to simultaneously control the accuracy of the first and second crevices 701, 702. Consequently, imaging resolution is increased, and optical performance of the lens module is enhanced as well.

2. The second crevice 702 can be set to be larger in size than the first crevice 701 such that it is relatively easy to assemble the second lens 52 into the second receiving sub-space of the receiving space 411 defined by the barrel wall 41 of the lens barrel 4.

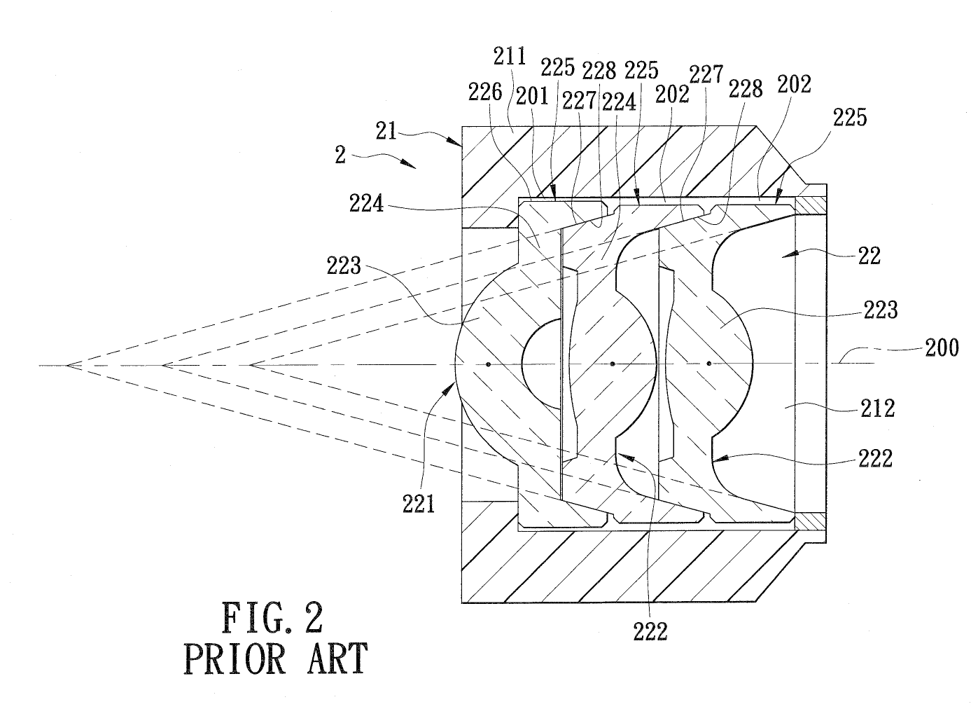

3. The first and second lenses 51, 52 are much smaller in size as compared to the prior art since the extension segments 225 of the conventional lens module 2 (shown in FIG. 2) are no longer required, thereby achieving the goal of reducing the size of the lens module.

4. Since the sizes of the first and second lenses 51, 52 are reduced, the amounts of materials required for manufacturing the first and second lenses 51, 52 are also reduced, thereby reducing the manufacturing cost of the lens module.

5. Since the inner and outer contact parts 528a, 528b of each of the protrusions 5240 are respectively disposed in point contact, instead of surface contact in the prior art, with the inner and outer groove edge parts 518a, 518b of the corresponding one of the groove walls 519, stress or deformation in the optically effective portions 515, 525 of the first and second lenses 51, 52 can be avoided. Consequently, imaging resolution is enhanced as compared to the prior art.

6. Since contact forces between the inner and outer contact parts 528a, 528b and the inner and outer groove edge parts 518a, 518b are moderate enough, it is not necessary to intentionally loosen the contacts for the purpose of ensuring alignment of the first and second centers of the optically effective portions 515, 525 of the first and second lenses 51, 52 with the optical axis 700. Therefore, optical performance of the lens module is enhanced.

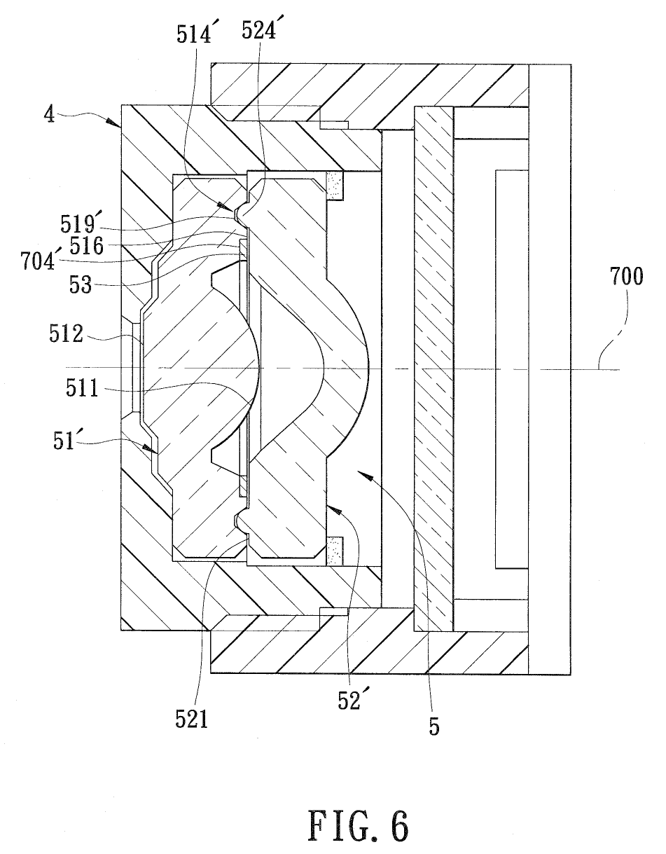

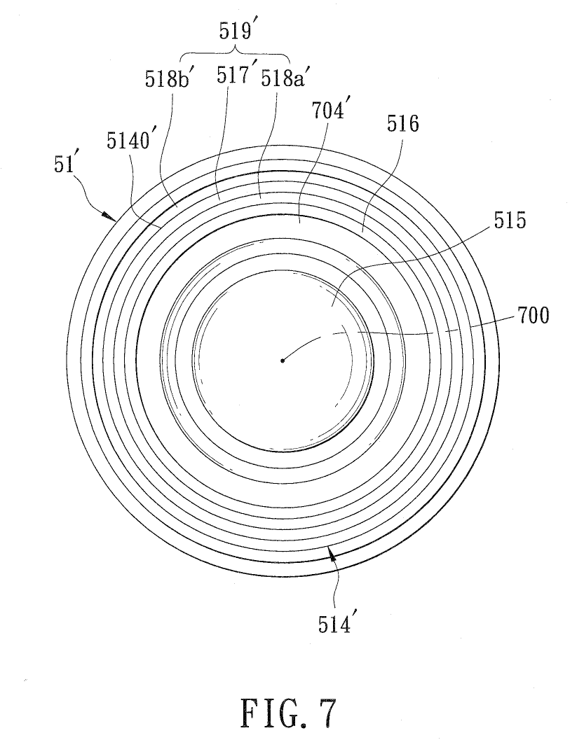

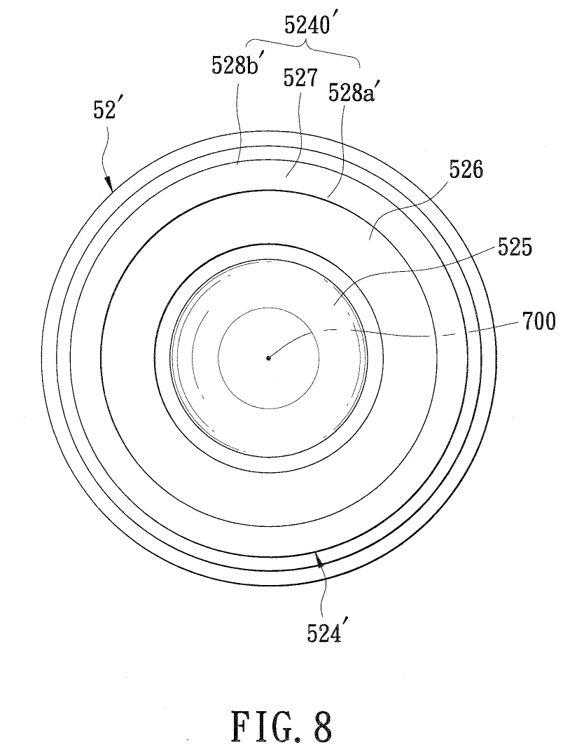

FIGS. 6, 7 and 8 respectively illustrate a sectional view of the second preferred embodiment of a lens module according to the present invention, a back view of the first lens 51′ according to the second preferred embodiment, and a front view of the second lens 52′ according to the second preferred embodiment. The second preferred embodiment differs from the first preferred embodiment in the groove unit 514′ of the first lens 51′ and the protrusion unit 524′ of the second lens 52′.

In this embodiment, the groove unit 514′ includes one groove wall 519′, which defines one groove 5140′. The groove 5140′ is an annular groove that extends circumferentially about the first center at the first positioning portion 516 from the first inner side 511 toward the first outer side 512.

The protrusion unit 524′ includes one protrusion 5240′. The protrusion 5240′ is an annular protrusion that extends circumferentially about the second center at the second positioning portion 526 from the second inner side 521 toward the first inner side 511, and that is received in the annular groove 5240′.

The groove bottom part 517′ of the groove wall 519′ is an annular flat surface that extends perpendicularly to the optical axis 700. The inner and outer groove edge parts 518a′, 518b′ extend away from each other at an angle with respect to the optical axis 700 and to the groove bottom part 517′. The inner and outer contact parts 528a′, 528b′ and the protrusion tip part 527′ of the protrusion 5240′ collectively form a convex ring shape. The inner and outer contact parts 528a′, 529b′ are disposed in line contact with the inner and outer groove edge parts 518a′, 519b′, respectively.

The second preferred embodiment further differs from the first preferred embodiment in that the annular screen-receiving groove 704′ is formed in the first inner side 511 of the first lens 51′ and is disposed between the groove unit 514′ and the first center.

Since the advantages achieved by the first preferred embodiment are also achieved by the second preferred embodiment, further details of the same are omitted herein for the sake of brevity.

It should be noted herein that the lens unit 5, 5′ may be sold independently of the lens barrel 4. In addition, the lens unit 5, 5′ may include more than two lenses in other embodiments of the present invention, where the above advantages are achieved as long as the lenses are arranged in the manner disclosed with reference to the first and second preferred embodiments.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A lens unit comprising:
a first lens having a first inner side and a first outer side opposite to said first inner side, and including a first optically effective portion that has a first center aligned with an optical axis, and a first positioning portion that surrounds said first optically effective portion, said first lens being provided with a groove unit that extends circumferentially about said first center at said first positioning portion from said first inner side toward said first outer side; and
a second lens having a second inner side confronting said first inner side of said first lens, and a second outer side opposite to said second inner side, said second lens including a second optically effective portion that has a second center aligned with the optical axis, and a second positioning portion that surrounds said second optically effective portion, said second lens being provided with a protrusion unit that extends circumferentially about said second center at said second positioning portion from said second inner side toward said first inner side, and that is received in said groove unit of said first lens.

2. The lens unit as claimed in claim 1, wherein said groove unit includes a groove wall that defines a groove and that includes a groove bottom part, said protrusion unit including a protrusion that has a protrusion tip part, which is spaced apart from said groove bottom part when said protrusion is received in said groove.

3. The lens unit as claimed in claim 2, wherein said groove wall further includes inner and outer groove edge parts that have said groove bottom part connected therebetween, said inner and outer groove edge parts being respectively disposed proximate to and distal from said first center, said protrusion further including inner and outer contact parts that have said protrusion tip part connected therebetween, said inner and outer contact parts being disposed in contact with said inner and outer groove edge parts, respectively.

4. The lens unit as claimed in claim 3, wherein said groove bottom part of said groove wall is a flat surface that extends perpendicularly to the optical axis, said inner and outer groove edge parts extending away from each other at an angle with respect to the optical axis and to said groove bottom part, said inner and outer contact parts and said protrusion tip part of said protrusion collectively forming a hemispherical shape, said inner and outer contact parts being disposed in point contact with said inner and outer groove edge parts, respectively.

5. The lens unit as claimed in claim 1, wherein said groove unit includes a plurality of grooves that are angularly spaced apart from each other, each of said grooves extending circumferentially about said first center at said first positioning portion from said first inner side toward said first outer side,
said protrusion unit including a plurality of protrusions that are angularly spaced apart from each other, each of said protrusions extending circumferentially about said second center at said second positioning portion from said second inner side toward said first inner side, and being received in a corresponding one of said grooves.

6. The lens unit as claimed in claim 3, wherein said groove is an annular groove that extends circumferentially about said first center at said first positioning portion from said first inner side toward said first outer side,
said protrusion being an annular protrusion that extends circumferentially about said second center at said second positioning portion from said second inner side toward said first inner side, and that is received in said annular groove.

7. The lens unit as claimed in claim 6, wherein said groove bottom part of said groove wall is an annular flat surface that extends perpendicularly to the optical axis, said inner and outer groove edge parts extending away from each other at an angle with respect to the optical axis and to said groove bottom part, said inner and outer contact parts and said protrusion tip part of said protrusion collectively forming a convex ring shape, said inner and outer contact parts being disposed in line contact with said inner and outer groove edge parts, respectively.

8. The lens unit as claimed in claim 1, further comprising an annular light-shading screen, said second positioning portion being formed with an annular screen-receiving groove for receiving said light-shading screen therein and for retaining said light-shading screen between said first and second lenses;
wherein said annular screen-receiving groove is formed in said second inner side of said second lens and is disposed between said protrusion unit and said second center.

9. The lens unit as claimed in claim 1, further comprising an annular light-shading screen, said first positioning portion being formed with an annular screen-receiving groove for receiving said light-shading screen therein and for retaining said light-shading screen between said first and second lenses;
wherein said annular screen-receiving groove is formed in said first inner side of said first lens and is disposed between said groove unit and said first center.

10. A lens module comprising:
a lens barrel including a barrel wall that defines an optical axis and a receiving space; and
a lens unit including
a first lens having a first inner side, a first outer side opposite to said first inner side, and a first peripheral surface interconnecting said first inner side and said first outer side, said first lens including a first optically effective portion that has a first center aligned with the optical axis, and a first positioning portion that surrounds said first optically effective portion, said first lens being provided with a groove unit that extends circumferentially about said first center at said first positioning portion from said first inner side toward said first outer side, said first lens being disposed in said receiving space such that a first crevice is formed between said first peripheral surface and said barrel wall, and
a second lens having a second inner side confronting said first inner side of said first lens, a second outer side opposite to said second inner side, and a second peripheral surface interconnecting said second inner side and said second outer side, said second lens including a second optically effective portion that has a second center aligned with the optical axis, and a second positioning portion that surrounds said second optically effective portion, said second lens being provided with a protrusion unit that extends circumferentially about said second center at said second positioning portion from said second inner side toward said first inner side, and that is received in said groove unit of said first lens, said second lens being disposed in said receiving space such that a second crevice is formed between said second peripheral surface and said barrel wall.

11. The lens module as claimed in claim 10, wherein said barrel wall of said lens barrel includes first and second wall segments that cooperate to form a step junction therebetween, and that respectively define first and second receiving sub-spaces of said receiving space, said first and second lenses of said lens unit being disposed respectively in said first and second receiving sub-spaces such that said first crevice is formed between said first peripheral surface of said first lens and said first wall segment of said barrel wall, and such that said second crevice is formed between said second peripheral surface of said second lens and said second wall segment of said barrel wall.

12. The lens module as claimed in claim 11, wherein size of said first crevice is smaller than that of said second crevice.

13. The lens module as claimed in claim 10, wherein said groove unit of said first lens includes a groove wall that defines a groove and that includes a groove bottom part, said protrusion unit of said second lens including a protrusion that has a protrusion tip part, which is spaced apart from said groove bottom part when said protrusion is received in said groove.

14. The lens module as claimed in claim 13, wherein said groove wall further includes inner and outer groove edge parts that have said groove bottom part connected therebetween, said inner and outer groove edge parts being respectively disposed proximate to and distal from said first center, said protrusion further including inner and outer contact parts that have said protrusion tip part connected therebetween, said inner and outer contact parts being disposed in contact with said inner and outer groove edge parts, respectively.

15. The lens module as claimed in claim 14, wherein said groove bottom part of said groove wall is a flat surface that extends perpendicularly to the optical axis, said inner and outer groove edge parts extending away from each other at an angle with respect to the optical axis and to said groove bottom part, said inner and outer contact parts and said protrusion tip part of said protrusion collectively forming a hemispherical shape, said inner and outer contact parts being disposed in point contact with said inner and outer groove edge parts, respectively.

16. The lens module as claimed in claim 10, wherein said groove unit of said first lens includes a plurality of grooves that are angularly spaced apart from each other, each of said grooves extending circumferentially about said first center at said first positioning portion from said first inner side toward said first outer side, said protrusion unit of said second lens including a plurality of protrusions that are angularly spaced apart from each other, each of said protrusions extending circumferentially about said second center at said second positioning portion from said second inner side toward said first inner side, and being received in a corresponding one of said grooves.

17. The lens module as claimed in claim 14, wherein said groove is an annular groove that extends circumferentially about said first center at said first positioning portion from said first inner side toward said first outer side,
said protrusion being an annular protrusion that extends circumferentially about said second center at said second positioning portion from said second inner side toward said first inner side, and that is received in said annular groove.

18. The lens module as claimed in claim 17, wherein said groove bottom part of said groove wall is an annular flat surface that extends perpendicularly to the optical axis, said inner and outer groove edge parts extending away from each other at an angle with respect to the optical axis and to said groove bottom part, said inner and outer contact parts and said protrusion tip part of said protrusion collectively forming a convex ring shape, said inner and outer contact parts being disposed in line contact with said inner and outer groove edge parts, respectively.

19. The lens module as claimed in claim 10, wherein said lens unit further includes an annular light-shading screen, said second positioning portion being formed with an annular screen-receiving groove for receiving said light-shading screen therein and for retaining said light-shading screen between said first and second lenses,
said annular screen-receiving groove being formed in said second inner side of said second lens and being disposed between said protrusion unit and said second center.

20. The lens module as claimed in claim 10, wherein said lens unit further includes an annular light-shading screen, said first positioning portion being formed with an annular screen-receiving groove for receiving said light-shading screen therein and for retaining said light-shading screen between said first and second lenses,
said annular screen-receiving groove being formed in said first inner side of said first lens and being disposed between said groove unit and said first center.
